(19) United States
(12) Patent Application Publication
(10) Pub. No.: US 2006/0080845 A1
(43) Pub. Date: Apr. 20, 2006

(54) Cutter assembly for electric shaver and process for making the same

(75) Inventors: David W. Everett JR., Verona, WI (US); Maciej Murzynski, Verona, WI (US); Ray Poole, Stoughton, WI (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 10/966,883

(22) Filed: Oct. 15, 2004

(51) Int. Cl. B26B 19/04; B26B 19/02

(52) U.S. Cl. 30/346.51; 30/43.92

(57) ABSTRACT

In a process for making a blade member for a cutter assembly of an electric shaver, a blade member blank is stamped from a strip of metal, with the blade member having opposite sides and a peripheral edge. An elongate channel is stamped into at least one side of the blade member blank, with the elongate channel having a generally arcuate cross-section for at least in part defining a blade member cutting edge having an acute cutting angle. In a cutter assembly for an electric shaver, a plurality of such blade members are mounted on a support shaft.

### FIELD OF INVENTION

The present invention relates generally to electric shavers, and more particularly to a process for making cutter assemblies for electric shavers wherein blade members of the cutter assembly each have acute angled cutting edges.

### BACKGROUND OF THE INVENTION

Electric shavers are commonly used to shave facial and body hair. Many people prefer electric shavers to razors because the cutting blades of electric shavers do not contact the skin. There is a belief that the lack of blade contact with the skin reduces the risk of nicks, cuts and other skin irritations. One conventional type of electric shaver type is commonly referred to as a foil shaver, wherein a cutter assembly comprised of multiple, parallel aligned blade members are disposed for joint reciprocation within a thin, flexible apertured foil or mesh screen. The cutting assembly is reciprocated relative to the foil, with cutting edges of the blade members in contact with the inner surface of the foil, so that the cutting edges of the blade members repeatedly cross the apertures formed in the foil. By sliding the outer surface of the foil over the skin surface to be shaven, individual short hairs enter the apertures formed in the foil and are cut by the cutting edges of the reciprocating blade members.

Cutting assemblies are typically constructed by securing the multiple blade members in parallel relationship with each other on a support shaft. Each of the blade members has a peripheral edge that is contoured to correspond generally to the cross-sectional shape of the foil to thereby facilitate flush contact between the blade members and the foil. The blade members are typically stamped out of a metal strip having a uniform thickness. As a result, the cutting edges (e.g., the peripheral edges) of such conventional blade members are generally squared, e.g., having a cutting angle of 90 degrees.

To provide a more effective cutting angle at the cutting edges of the blade members, it is known to stamp opposed V-shaped (in cross-section) indentations or channels (FIG. 6) into the opposite sides of each blade member generally adjacent the peripheral edge thereof to form a sharper (e.g., acute) cutting angle α. However, to form the desired cutting angle using V-shaped indentations requires the apex of each indentation to cut relatively deep into the opposite sides of the blade members. This substantially thins the blade members at the indentations, thereby weakening the blade members at the indentations. Stamping the V-shaped indentations also requires the punch and die set used for stamping to generally have an apex, which is easily worn such that the punch and die set requires frequent replacement.

There is a need, therefore, for a process for making cutter assemblies in which the blade members have angled cutting edges wherein wear on the punches is reduced and the integrity of the blade members is increased, and for blade members made according to such a needed process.

### SUMMARY OF THE INVENTION

In one embodiment, a process for making a blade member for a cutter assembly of an electric shaver generally comprises stamping a blade member blank from a strip of metal, with the blade member having opposite sides and a peripheral edge. An elongate channel is stamped into at least one side of the blade member blank, with the elongate channel having a generally arcuate cross-section for at least in part defining a blade member cutting edge having an acute cutting angle.

In one embodiment of a blade member for an electric shaver cutter assembly, the blade member has opposite sides, a peripheral edge, and an elongate channel formed in at least one of its opposite sides in generally parallel relationship with the peripheral edge of the blade member. The elongate channel and the peripheral edge of the blade member together define a cutting edge of the blade member, with the cutting edge having an acute cutting angle. The elongate channel is generally arcuate in cross-section.

In another embodiment, a cutter assembly for an electric shaver generally comprises a plurality of blade members mounted on a support shaft, each blade member having opposite sides, a peripheral edge, and an elongate channel formed in at least one of its opposite sides in generally parallel relationship with the peripheral edge of the blade member. The elongate channel and the peripheral edge of the blade member together defining a cutting edge of the blade member, with the cutting edge having an acute cutting angle. The elongate channel is generally arcuate in cross-section.

### BRIEF DESCRIPTION OF THE DRAWINGS

FIG. 1 is a perspective view of a prior art foil-type electric shaver;

FIG. 2 is a perspective view of the prior art shaver shown in FIG. 1 with portions of the shaver exploded to show internal construction;

FIG. 3 is a front elevation of a cutter assembly according to one embodiment of the present invention for use with an electric shaver such as the electric shaver of FIG. 1;

FIG. 4 is a side elevation of a blade member according to one embodiment of the present invention for the cutter assembly of FIG. 3;

FIG. 5 is a section view taken in the plane of line 5-5 of FIG. 4;

FIG. 6 is an enlarged detail of a portion of the section of FIG. 5;

FIG. 7 is an enlarged detail of a portion of a prior art blade member for a conventional foil-type shaver cutter assembly;

FIG. 8 is a schematic of apparatus for making a cutter assembly according to one embodiment of a process of the present invention;

FIG. 9a is a fragmented top plan view of a metal strip after passing through a first die set of a stamping station of the apparatus of FIG. 8;

FIG. 9b is a fragmented top plan view of the metal strip after passing through a second die set of the stamping station of the apparatus of FIG. 8;

FIG. 9c is a fragmented top plan view of the metal strip after passing through a third die set of the stamping station of the apparatus of FIG. 8;

FIG. 9d is a fragmented top plan view of the metal strip after passing through a fourth die set of the stamping station of the apparatus of FIG. 8; and

FIG. 10 is a section view of the third die set of the stamping station of the apparatus of FIG. 8 with a blade member blank being stamped by the third die set.

Corresponding reference characters indicate corresponding parts throughout the drawings.

### DETAILED DESCRIPTION

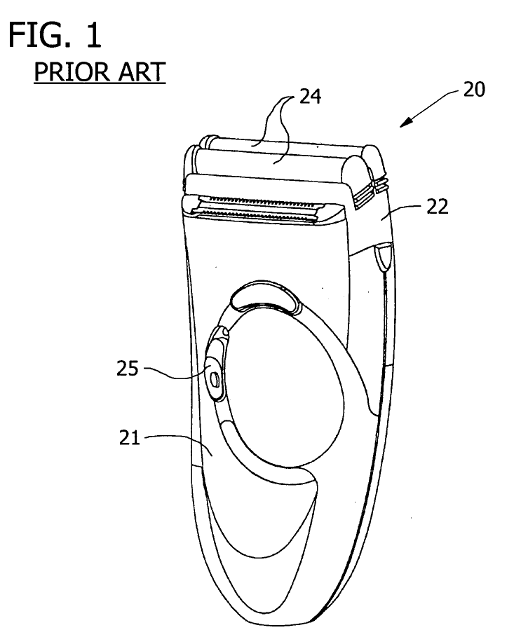

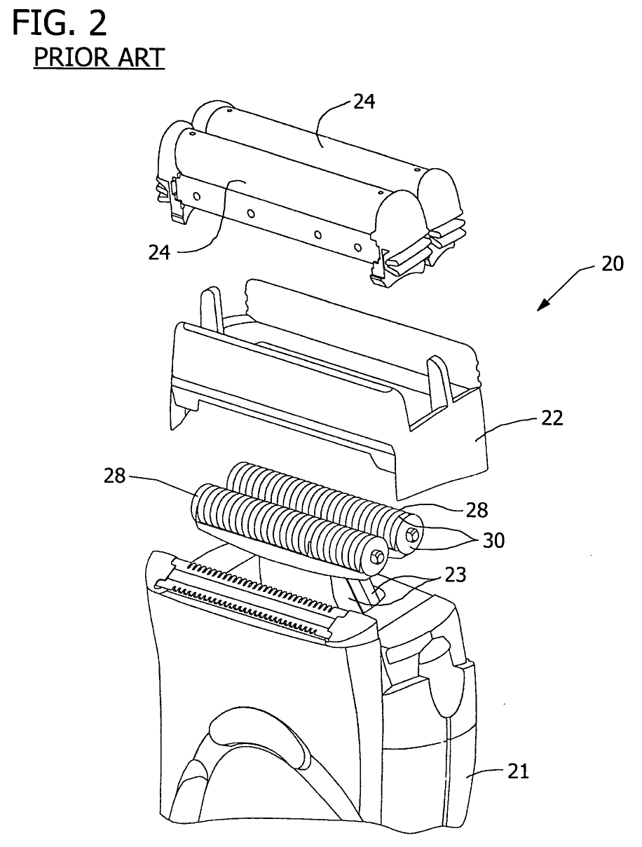

Referring now to the drawings and in particular to FIGS. 1 and 2, the process of the present invention is useful in making cutter assemblies, and more particularly for making blade members for cutter assemblies, for use in electric shavers such as the conventional foil-type shaver shown in FIG. 1 and indicated generally therein at 20. The shaver 20 generally comprises a housing 21 and a guard/cover support base 22 releasably mounted thereon to permit removal of the support base for cleaning/changing of various components of the shaver. The housing 21 houses a motor (not shown) which is operatively connected to a pair of carriages 23 (FIG. 2) that are driven by the motor to move relative to the housing in a side-to-side reciprocating motion upon operation of the motor. A cutter assembly 28 (FIG. 2) is mounted on each of the carriages 23, with the cutter assemblies being separate and independent from each other in parallel spaced relationship. A pair of apertured foils 24 (also often referred to as mesh screens) are mounted on the guard/cover support base 22 to extend side-to-side in parallel relationship with each other in accordance with the cutter assemblies 28. The cutter assemblies 28 are suitably biased into contacting, hair cutting relationship with the inner surfaces of the respective apertured foils 24. The apertured foils 24 and cutter assemblies 28 are also constructed and arranged to permit flexing movement relative to the housing 21 during use, while the cutter assemblies remain in contact with the apertured foils.

Activation of an on/off switch 25 (FIG. 1) operates the motor to drivingly reciprocate the cutter assemblies 28 in side-to-side movement while in contact with the inner surfaces of the apertured foils 24. The apertured foils 24 are guided (e.g., in a sliding movement) over the skin surface being shaved to facilitate short hairs extending through the apertures in the foils. As blade members 30 of the cutter assembly 28 pass back and forth over the foil apertures 24 while in contact with the inner surfaces of the foils 24, hairs that extend through the aperture are cut by the blade members. Further construction and operation of the electric shaver 20 shown in FIG. 1 is described in co-assigned U.S. Pat. No. 6,601,302 (Andrew), the entire disclosure of which is incorporated herein by reference to the extent it is consistent with the present disclosure.

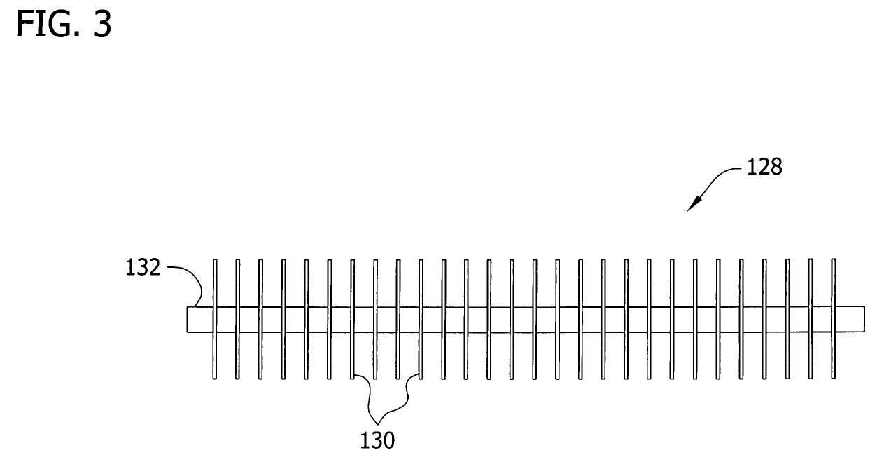

With particular reference now to FIG. 3, a cutter assembly, generally indicated at 128, of the present invention, such as can be used in place of the cutter assembly 28 of the shaver 20 shown in FIG. 1, generally comprises a plurality of blade members 130 mounted on a support shaft 132 in parallel spaced relationship with each other. While a total of 28 blade members 130 are shown in the illustrated embodiment of FIG. 3, it is understood that the number of blade members may vary, and that the cutter assembly 128 may comprise a single blade member, without departing from the scope of this invention. The support shaft 132 of the illustrated embodiment is approximately 1.62 inches in length, with the blade members 130 having a pitch (e.g., spacing between blade members) of about 0.055 inches over a length of about 1.5 inches of the shaft.

A segment 134 of a peripheral edge 136 of each blade member 130 suitably has a contour that generally accords with the contour of the inner surface of the apertured foil 24 to provide a generally flush contact therebetween. In the illustrated embodiment, each blade member 130 is generally circular so that an arcuate segment 134 of the peripheral edge 136 of each blade member has a contour that matches the contour of the foil 24 regardless of the angular orientation at which the blade member 130 is mounted on the support shaft 132. It is understood, however, that the blade member 130 need not be circular, such that only a defined segment of the peripheral edge of the blade member has the desired contour that accords with the contour of the apertured foil 24. The segment 134 of the blade member peripheral edge 136 that contacts the inner surface of the apertured foil 24 broadly defines a cutting edge for cutting hairs that extend through the apertures of the foil.

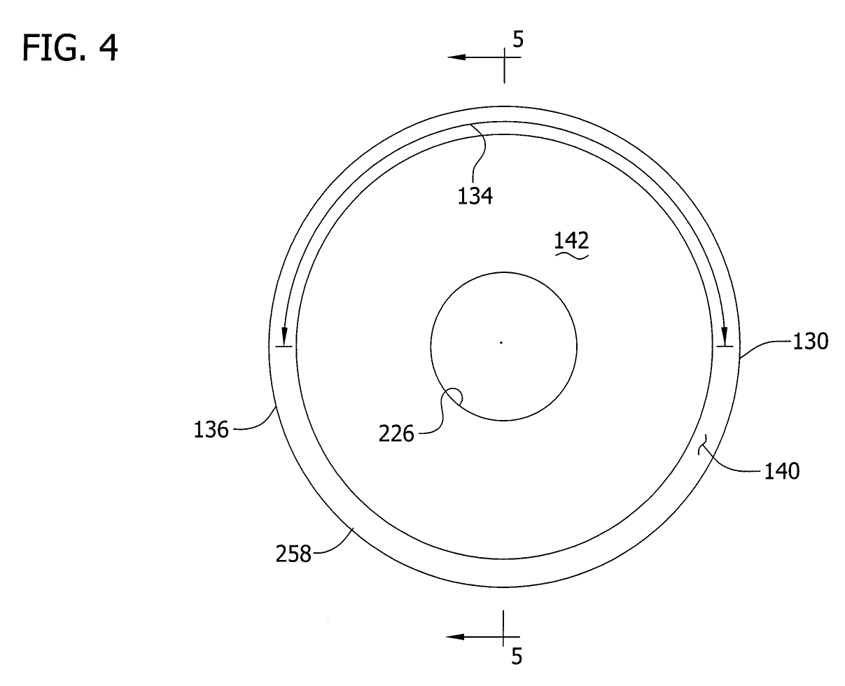

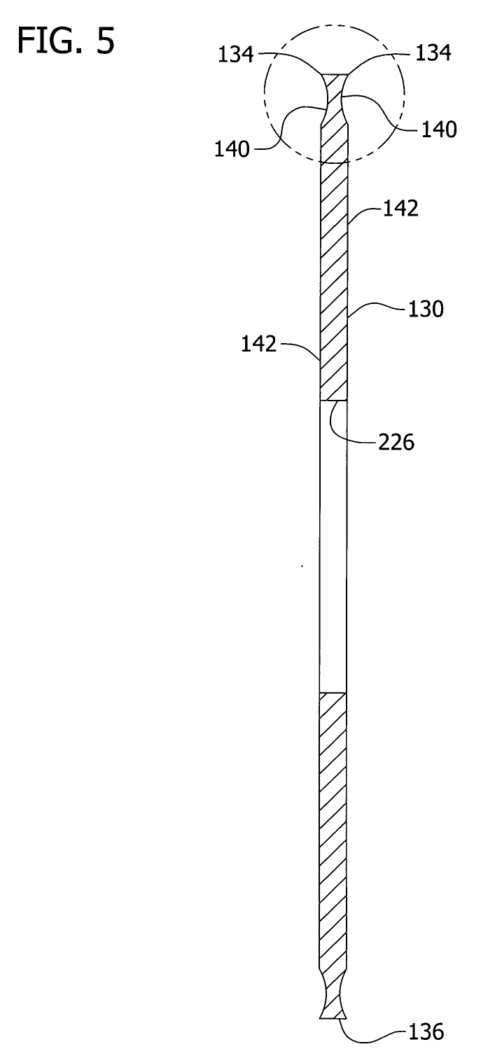

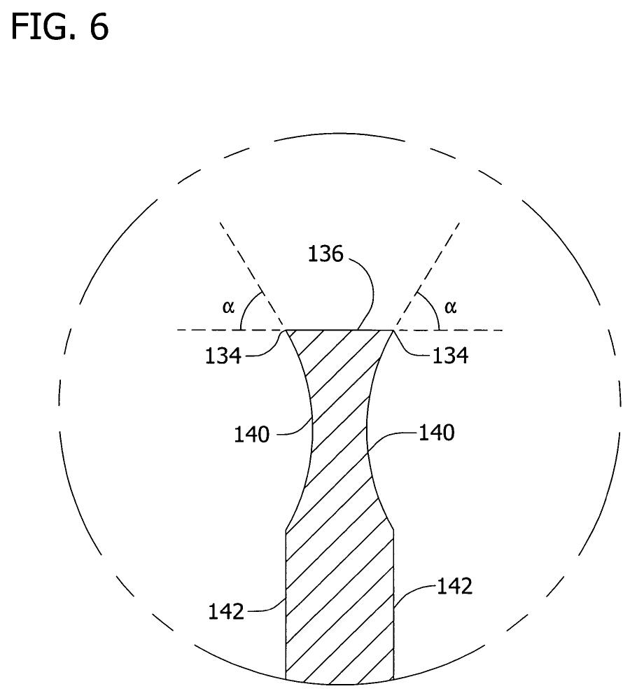

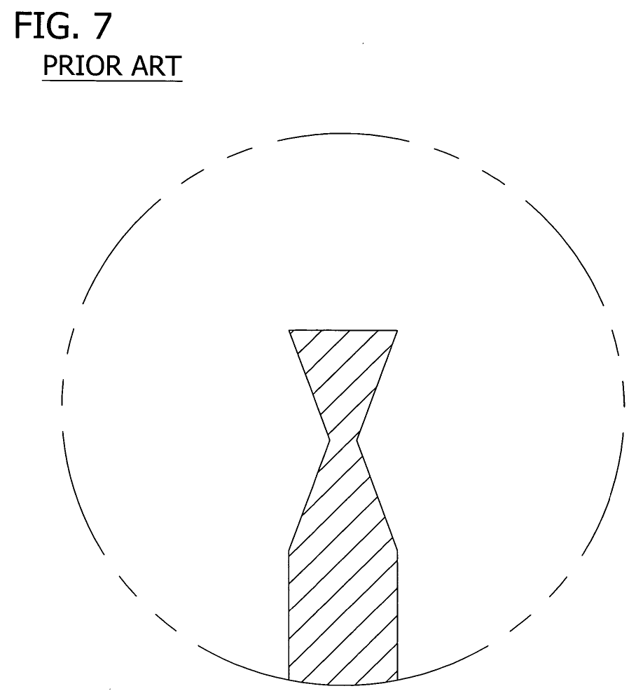

As best seen in FIGS. 4 and 5, opposed elongate channels 140 (broadly, indentations) are formed in opposite sides 142 of each blade member 130 along the length of the cutting edge 134. In the illustrated embodiment the elongate channels 140 are annular to extend about the entire blade member 130. However, as described previously, the cutting edge 134 need only extend along the segment of the peripheral edge 136 of the blade member 130 that is in contact with the inner surface of the foil 24. Consequently, it is understood that the elongate channels 140 formed in the opposite sides 142 of each blade member 130 need not be annular to remain within the scope of this invention. The elongate channels 140 are each suitably arcuate in cross-section such that the maximum depth of each channel is other than at a point (e.g., the channel is other than generally V-shaped in cross-section as in prior art blade members such as that shown in FIG. 7). As an example, the elongate channels 140 formed in the blade member 130 illustrated in FIG. 6 each have an arcuate cross-section having a radius in the range of about 0.01 to about 0.03 inches, and more suitably about 0.015 inches. The thickness of the blade member 130 (other than at the elongate channels 140) is approximately 0.009 inches and the depth of each elongate channel (e.g., into the thickness of the blade member) is about 0.0025 inches.

The arcuate channels 140 formed in each blade member 130, together with the peripheral edge 136 thereof, define an acute cutting angle α of the blade member along the cutting edge 134 thereof. The cutting angle α is suitably in the range of about 70 to about 80 degrees. For example, the acute cutting angle α of the blade member 130 shown in FIG. 6 is about 75 degrees. However, the cutting angle may be other than within the above range without departing from the scope of this invention.

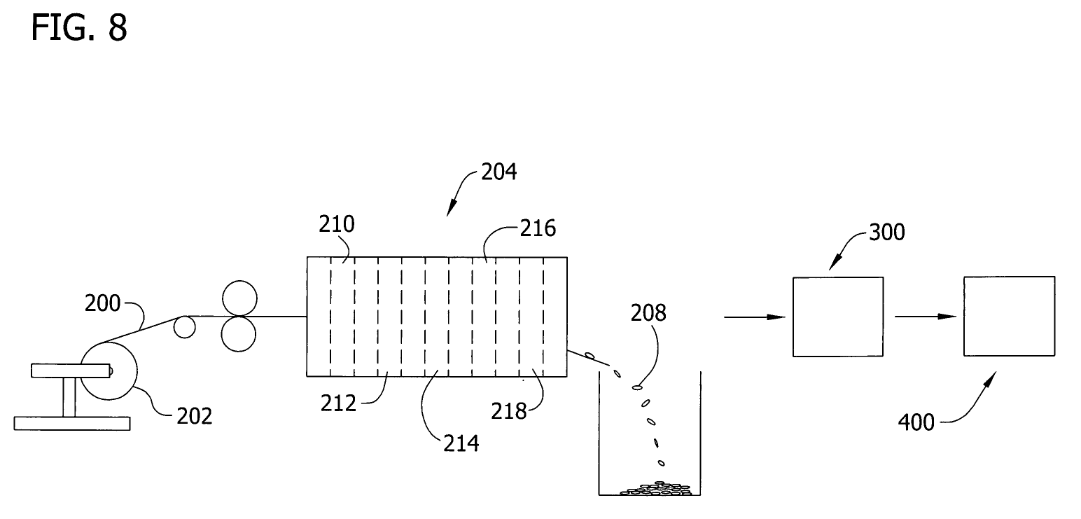

FIG. 8 is a schematic of apparatus for making a cutter assembly, and more particularly for making blade members for a cutter assembly such as the cutter assembly 128 described above, according to one embodiment of a process of the present invention for making such a cutter assembly. In general, an elongate, generally flat strip 200 of metal is fed from a supply roll 202 (e.g., a coil) to a stamping apparatus, generally indicated at 204, for stamping blade member blanks from the metal strip. As an example, the metal strip 200 may suitably comprise stainless steel. However, it is understood that other suitable metals may be used to make the blade members 130 of the cutter assembly 128 and remain within the scope of this invention.

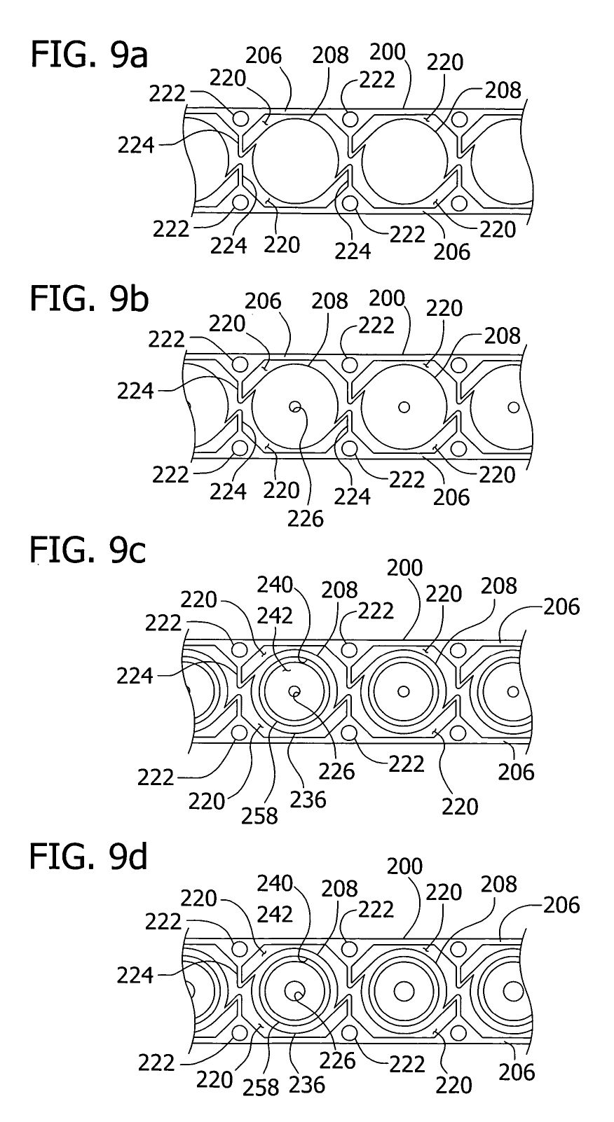

The width of the strip 200 can vary, but is suitably substantially wider than the planar dimensions of the blade members 130 to be formed from the strip so that there is a margin 206 (FIG. 9a) between the edges of the strip and blade member blanks 208 formed in the strip. For example, in the illustrated embodiment of FIG. 9a the strip 200 is suitably wider than the diameter of the circular blade member blanks 208 formed from the strip. The thickness of the metal strip 221 is approximately equal to the desired end thickness of the blade members 130 (i.e., other than at the elongate channels 140). As an example, the thickness of the strip 200 shown in FIG. 9a, is about 0.009 inches. It is understood, however, that the thickness of the metal strip 200 may be other than the above without departing from the scope of this invention.

With reference back to FIG. 8, the stamping apparatus 204 comprises a progressive die apparatus having a series of die sets 210, 212, 214, 216, 218 arranged in sequential relationship in the direction of movement of the strip 200 so that the strip passes through each of the die sets, one-after-another during manufacture. In the die apparatus of the illustrated embodiment, the first die set 210 forms relief openings 220 (FIG. 9a) in the metal strip 200, e.g., to generally defined each blade member blank 208 to be formed in the strip, along with registration holes 222. The relief openings 220 partially sever the blade member blanks 208 from the strip 200 such that the blanks remain connected to the strip only by connecting tabs 224. The purpose of the relief openings 220 is to generally isolate the blanks 208 from the rest of the strip 200 as the blanks are further formed at subsequent die sets 212, 214, 216, 218 so that stresses from the forming process do not deform the edge margins of the strip. The relief openings 220 also allow for adequate metal flow during the subsequent stamping of elongate channels therein without distorting the metal strip 200. The registration holes 222 are for use in properly locating the blanks 208 on the die sets 212, 214, 216, 218 used in subsequent stamping operations.

The blade member blank 208 defined by the relief openings 220 suitably has the general shape of the finished blade member 130, but is of greater dimension in the plane of the blade member blank 208, and more suitably along the segment of the blank at which the cutting edge 134 of the finished blade member is to be formed, to allow a peripheral edge 236 of the blade member blank to be ground down in subsequent finishing operations as described later herein. As an example, in the illustrated embodiment the circular blade member blank 208 defined by the relief openings 220 formed in the metal strip 200 shown in FIG. 9a initially has a diameter of about 0.283 inches, whereas the finished blade member 130 (FIGS. 4 and 5) has a diameter of approximately 0.275 inches.

As seen best in FIG. 9b, the second die set 212 of the stamping apparatus 204 stamps a hole 226 in each blade member blank 208 to correspond generally to the hole through which the support shaft 132 extends upon mounting the blade member 130 thereon. This hole 226 is suitably formed prior to stamping the elongate channels in the blade member blanks 208 to permit the radial inward flow of metal during stamping of the elongate channels. However, it is contemplated that the support shaft hole 226 may be formed after stamping the elongate channels into the blade member blanks 208 without departing from the scope of this invention. The support shaft opening 226 may suitably be sized smaller than the diameter of the support shaft 132, as long as a sufficient amount of material is removed from the blade member blank 208 to allow for adequate metal flow during stamping of the elongate channels.

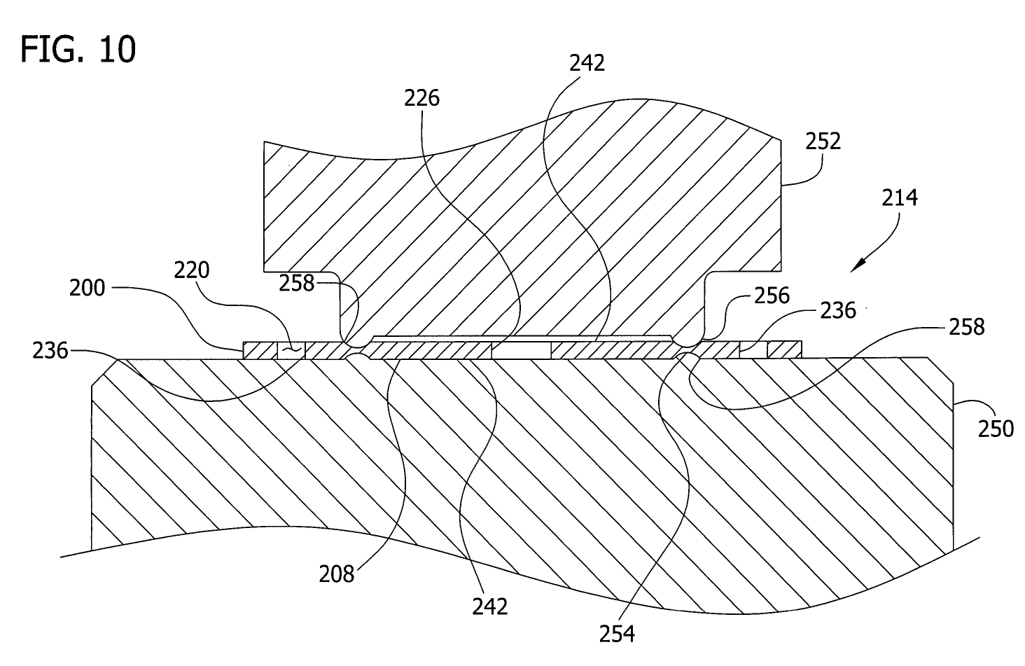

At the third die set 214 (FIGS. 9c and 10), opposed elongate channels 240 are simultaneously stamped into the opposite sides 242 of each of the blade member blanks 208. In one particular embodiment, shown in FIG. 11, the die set 214 comprises a die 250 and opposed punch 252 that are driven toward each other to compress the blade member blank 208 therebetween. The die 250 and punch 252 each have a respective elongate bump 254, 256 having in cross-section an arcuate surface corresponding generally to the arcuate shaped cross-section of the elongate channels 240 to be stamped into the blanks 208. In the illustrated embodiment, the die 250 and punch 252 each have annular elongate bumps 254, 256 to form annular elongate channels 240 in the blade member blanks 208. However, it is understood that the elongate bumps 254, 256 may be other than annular, and more suitably the bumps may be configured to form elongate channels 240 only along the segment of the blade member blank that will become the cutting edge of the finished blade member 130. Upon stamping the elongate channels 240 into the blade member blank 208, metal is displaced from the channels and flows both inward (e.g., toward the support shaft opening) and outward (e.g., toward the relief openings).

The elongate channels 240 are suitably stamped into the blade member blank 208 at a location such that the outer edges 258 of the channels (e.g., nearest the peripheral edge 236 of the blank) are spaced inward of the peripheral edge of the blade member blank. This allows for removing material from the peripheral edge 236 of the blade member blank 208 (e.g., reducing the diameter of the blade member blank 208 of the illustrated embodiment) without distorting the shape of the elongate channels 240.

The support shaft opening 226 is subsequently stamped to its desired final dimension (e.g., for receiving the support shaft 132 therethrough) at the fourth die set 218 as shown in FIG. 9d). It is contemplated, however, that the support shaft opening 226 may be stamped to a sufficient size by the second die set 212, e.g., so that the opening will be sized to its desired final dimension following inward metal flow upon stamping of the elongate channels 240, without departing from the scope of this invention. The fifth die set 218 subsequently severs the blade member blank 208 from the metal strip 200. The discrete blade member blanks 208 are then transferred to an assembly station, generally indicated at 300 in FIG. 8, at which the blade member blanks are assembled on a support shaft 132, and to a finishing station, generally indicated at 400 in FIG. 8, at which material is removed from the peripheral edge 236 of each blade member blank 208 (at least along the segment thereof that becomes the cutting edge 134 of the finished blade member 130). For example, material is suitably removed from the peripheral edge 236 of each blade member blank 208 inward to the outer edges 258 of the elongate channels 240 so that the elongate channels and peripheral edge of each blade member blank together define the cutting edge 134 of the blade member 130 having the desired acute cutting angle. In the illustrated embodiment, approximately 0.005 to about 0.010 inches are removed from the peripheral edge each blade member blank. In a particular embodiment, the finishing station 400 comprises a suitable grinding device for grinding down the peripheral edge 236 of the blade member blank 208 to the desired final dimensions of the blade member.

The cutter assembly 128 can be provided as one of the original cutter assemblies of a shaver such as the shaver 20 of FIG. 1, or provided as a replacement cutter assembly for such a shaver. The cutter assembly 128 can also be provided as a replacement assembly for an electric shaver that was originally equipped with conventional cutter assemblies.

Although the embodiment shown and described herein involves stamping a single row of blade member blanks 208 into a metal strip 200 that is only slightly wider than an individual blank, those skilled in the art will recognize that it is possible to stamp multiple rows of blade member blanks (e.g., four or more rows) into a wider metal strip without departing from the scope of this invention.

Also, while the cutter assembly 128 shown and described herein comprises a single cutting edge 134 (e.g., such that two discrete cutter assemblies are required in the shaver 20 of FIG. 1 having two apertured foils 24, it is contemplated that a single cutter assembly having a plurality of unitary blade members having two cutting edges (e.g., one corresponding to each of the apertured foils) may be made by the present process without departing from the scope of this invention. Such a unitary blade member is disclosed in co-assigned U.S. Pat. No. 5,138,767 (Locke), the entire disclosure of which is incorporated herein by reference to the extent that it is consistent herewith. It is also understood that only one cutter assembly 128 having a single cutting edge 134, or more than two cutter assemblies 128, may be made in accordance with the present process for us0 in an electronic shaver and remain within the scope of this invention.

When introducing elements of the invention or the preferred embodiments thereof, the articles “a”, “an”, “the” and “said” are intended to mean that there are one or more of the elements. The terms “comprising”, “including”, and “having” are intended to mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A process for making a blade member for a cutter assembly of an electric shaver, said blade member having an acute cutting angle at a cutting edge thereof, the process comprising:
stamping a blade member blank from a strip of metal, said blade member having opposite sides and a peripheral edge, and
stamping an elongate channel into at least one side of the blade member blank, the elongate channel having a generally arcuate cross-section for at least in part defining said blade member cutting edge having an acute cutting angle.

2. The process set forth in claim 1 wherein the step of stamping an elongate channel into at least one side of the blade member blank comprises stamping said elongate channel into said at least one side of the blade member blank generally parallel to the peripheral edge of the blade member blank.

3. The process set forth in claim 1 wherein the step of stamping an elongate channel into at least one side of the blade member blank comprises stamping said elongate channel into said at least one side of the blade member blank such that an outer edge of the elongate channel is in spaced relationship with the peripheral edge of the blade member blank, the process further comprising the step of removing material from the peripheral edge of the blade member to generally adjacent the elongate channel stamped into said at least one side of the blade member blank, the outer edge of the elongate channel and the peripheral edge following the material removing step together defining the cutting edge of the blade member having an acute cutting angle.

4. The process set forth in claim 3 wherein the material removing step comprises grinding down the peripheral edge of the blade member to adjacent the outer edge of the elongate channel.

5. The process set forth in claim 1 wherein the step of stamping an elongate channel into at least one side of the blade member blank comprises stamping opposed elongate channels into the opposite sides of the blade member blank, each of said elongate channels having a generally arcuate cross-section.

6. A blade member for an electric shaver cutter assembly, said blade member having opposite sides, a peripheral edge, and an elongate channel formed in at least one of said opposite sides in generally parallel relationship with the peripheral edge of said blade member, the elongate channel and the peripheral edge of said blade member together defining a cutting edge of the blade member, said cutting edge having an acute cutting angle, said elongate channel being generally arcuate in cross-section.

7. The blade member set forth in claim 6 wherein opposed elongate channels are formed in the opposite sides of the blade member in generally parallel relationship with the peripheral edge of the blade member, the peripheral edge of the blade member and the elongate channels together defining opposed cutting edges each having an acute cutting angle, each of the elongate channels being generally arcuate in cross-section.

8. The blade member set forth in claim 6 wherein the elongate channel has a radius in the range of about 0.01 inches to about 0.03 inches.

9. The blade member set forth in claim 6 wherein the elongate channel extends less than about the entire blade member.

10. A cutter assembly for an electric shaver, said cutter assembly comprising a plurality of blade members mounted on a support shaft, each blade member having opposite sides, a peripheral edge, and an elongate channel formed in at least one of said opposite sides in generally parallel relationship with the peripheral edge of said blade member, the elongate channel and the peripheral edge of said blade member together defining a cutting edge of the blade member, said cutting edge having an acute cutting angle, said elongate channel being generally arcuate in cross-section.
